(19) United States
(12) Patent Application Publication
(10) Pub. No.: US 2011/0133981 A1
(43) Pub. Date: Jun. 9, 2011

(54) SYSTEM AND METHOD FOR THE THREE DIMENSIONAL LOCATING OF AN OBJECT IN A VOLUME

(75) Inventors: Didier Magnon, Saint Georges Les Baillargeaux (FR); Joël Paquereau, Chasseneuil du Poitou (FR); Stéphane Besnard, Bavent (FR); Jérôme Billoué, Chatellerault (FR); Malika Moulessehoul, Poitiers (FR)

(73) Assignee: UNIVERSITE FRANCOIS RABELAIS DE TOURS, Tours Cedex 1 (FR)

(21) Appl. No.: 12/307,884

(22) PCT Filed: Jul. 25, 2007
(86) PCT No.: PCT/FR2007/001277

§ 371 Date: Sep. 22, 2009

(30) Foreign Application Priority Data
Jul. 25, 2006 (FR) 0606811

(51) Int. Cl. G01S 13/06

(52) U.S. Cl. 342/146

(57) ABSTRACT

The invention relates to a system for locating an object in a volume comprising:—a first matrix of scanning antennas positioned in a first plane;—first detection means arranged so as to detect a first signal received by the object in response to a first electromagnetic signal emitted by the first matrix towards the volume;—first means of two-dimensional locating that are arranged so as to determine the position of a projection of the object into the first plane as a function of the first signal received; in which the system comprises:—a second matrix of scanning antennas which is positioned in a second plane, the second plane not being parallel to the first plane, second detection means arranged so as to detect a second signal received by the object in the volume in response to a second electromagnetic signal emitted by the second matrix of antennas towards the volume;—second means of two-dimensional locating which are arranged so as to determine the position of a projection of the object in the second plane as a function of the second signal received;—means of three-dimensional locating arranged to locate the object in a reference frame formed by the first plane and the second plane, as a function of the position of the object in the first plane and in the second plane.

### CROSS-REFERENCE TO RELATED APPLICATIONS

This application is a National Phase Entry of International Application No. PCT/FR 2007/001277, filed Jul. 25, 2007, claiming priority to French Patent Application No. 06/06811, filed Jul. 25, 2006, both of which are incorporated herein by reference.

### BACKGROUND AND SUMMARY

The invention relates to a system and a method for the three-dimensional locating of an object in a volume.

Methods and devices are known for locating an object in a volume. A three-dimensional radar with electronic scanning makes it possible to fix objects in a volume. Such a radar comprises an array of identical antennas in a plane. The same signal is directed to each of the antennas in the array of antennas but with a different phase, which can be controlled by an electronic control device. By sequentially changing this phase, the antennas emit a signal in a measurement volume in a plurality of directions. If an object capable of reflecting or capturing the wavelength of the signal emitted by the antennas is comprised within the volume covered by the array of antennas, this object reflects or captures the signal. The analysis of the received signal then makes it possible to determine the position of the object in the emission volume by correlating the intensity of the signal received with the time at which it is received.

Such a radar is therefore a system for locating an object in a volume comprising:
a first array of scanning antennas positioned in a first plane;
first detection means arranged so as to detect a first signal received by said object in response to a first electromagnetic signal emitted by said first array towards said volume;
first two-dimensional locating means arranged so as to determine the position of a projection of said object in said first plane according to said first signal received.

However, such radars are used to detect objects within large volumes, for example in airspace for military applications. Thus, in a conventional fashion, the propagation time is necessary for location. The locating precision, however, is not satisfactory for high-precision applications, in particular in the field of medicine. This lack of precision is due, in particular, to the array of antennas, which must include the largest possible number of antennas in order to reduce the secondary lobes which are intrinsic in the elementary antenna. The aim of this is only to retain one main lobe, which is refined with a growing number of antennas and which corresponds to an emission or reception maximum. The relatively large size of these lobes in the known systems makes them unsuitable for obtaining a satisfactory resolution of the system.

Furthermore, these radar systems require a measurement of the echo of the wave received by the object to be detected in order to be able to perform three-dimensional location. However, such an echo measurement is difficult in highly opaque volumes, since the quantity of the echo signal can be too small to perform an accurate measurement, and the electromagnetic properties of each medium passed through modify the speed of propagation of the electromagnetic waves. The invention aims mainly to solve this disadvantage, in particular in non-homogeneous media having different electromagnetic properties.

One aim of the invention is therefore to allow the three-dimensional locating of an object in a volume without needing to measure the return wavelength reflected by the object in the volume, in particular when the volume is a non-homogeneous medium. Furthermore, in fields that require high precision, and in particular in the field of medicine, devices and methods are known for locating an electrode when it is inserted into a human body, in particular with a view to performing electrotherapy. In such medical procedures, an electrode is inserted, for example, in the brain of a patient, and the physiological activity captured by the electrode is detected. This physiological activity is characteristic of the position of the electrode in the brain and, based on general medical knowledge, the relationship is determined between a signal received by the electrode and the position of this electrode. However, such a locating process is very inaccurate and does not take into consideration the particular specific features of each volume in which an object is to be located.

The invention aims to solve the disadvantages of the prior art in terms of the three-dimensional locating of an object in a volume. One aim of the invention is to provide a device and a method allowing the precise locating of an object in a volume, in particular in a non-homogeneous volume, for example made up of a part of a human body. Another aim of the invention is to provide such locating in a three-dimensional frame of reference. Another aim of the invention is to make it possible to follow the trajectory of a moving object within a volume, rapidly determining data for locating the object in the volume.

For this purpose, the invention relates to a system for locating an object in a volume, comprising:
a first array of scanning antennas positioned in a first plane;
first detection means arranged so as to detect a first signal received by said object in response to a first electromagnetic signal emitted by said first array towards said volume;
first two-dimensional locating means arranged so as to determine the position of a projection of said object in said first plane according to said first signal received; said system comprising;
a second array of scanning antennas positioned in a second plane, said second plane being non-parallel to said first plane;
second detection means arranged so as to detect a second signal received by said object in response to a second electromagnetic signal emitted by said second array of antennas towards said volume;
second two-dimensional locating means arranged so as to determine the position of a projection of said object in said second plane according to said second signal received;
three-dimensional locating means arranged so as to locate said object in a frame of reference made up of said first plane and said second plane, according to the position of said object in said first plane and in said second plane.

According to the invention, two arrays of scanning antennas are therefore positioned in two non-parallel planes. By analysing the signal received by the object from the antennas of the first array of antennas, the first two-dimensional locating means can determine the position of a projection of the object in the first plane. This is carried out thanks to the scanning inside the first array. This signal received by the object in response to a signal emitted by the antennas of the first plane is detected by the first detection means and transmitted to the first two-dimensional locating means. In the same way, by analysing the signal received by the object from the antennas of the second array of antennas, the second two-dimensional locating means can determine the position of the object in the second plane. This signal received by the object in response to a signal emitted by the antennas of the second plane is detected by the second detection means and transmitted to the second two-dimensional locating means. The three-dimensional locating means can then determine the position of the object in the volume comprised between the first plane and the second plane.

Unlike the scanning radar systems of the prior art, the invention makes it possible to locate an object in a volume without measuring an echo, and more precisely without determining the distance from the object to the plane of the antenna according to the delay of the echo in relation to the wave emitted towards the object. According to one specific embodiment of the invention, in order to facilitate the three-dimensional reconstruction calculations by the three-dimensional locating means, said first plane and said second plane can be orthogonal.

Also according to a specific embodiment of the invention allowing two-dimensional locating with the help of first two-dimensional locating means and second two-dimensional locating means, said system can include first scanning means capable of causing the sequential generation of a first electromagnetic antenna signal by each of the antennas of said first array of antennas, and second scanning means capable of causing the sequential generation of a second electromagnetic antenna signal by each of the antennas of said second array of antennas, said first two-dimensional locating means comprising first correlating means arranged so as to determine a first antenna of said first array of antennas having generated a maximum energy of the first signal received, said second two-dimensional locating means comprising second correlating means arranged so as to determine a second antenna of said second array of antennas having generated a maximum energy of the second signal received. The system as defined above is particularly advantageous when the object is a ferromagnetic object, for example an electrode, and the volume is a non-homogeneous medium, for example a brain. This system thus makes it possible precisely to locate the ferromagnetic object in the non-homogeneous medium.

Also according to one embodiment of the invention, in order to follow the movement of the object in the volume, said system can include means for viewing the volume arranged so as to display a three-dimensional image of said volume, and superimposing means arranged so as to display a representation of said object on said three-dimensional image, according to the position of said object in said frame of reference. Also according to one embodiment of the invention, in order to be able to change the phase shift between the antennas of the first array of antennas, said system can include a first digital symbol generator capable of generating a first binary code, and a first modulator capable of modulating the phase of each of the antennas of said first array of antennas according to said first binary code. Also according to one embodiment of the invention, in order to be able to change the phase shift between the antennas of the second array of antennas, said system can include a second digital symbol generator capable of generating a second binary code, and a second modulator capable of modulating the phase of each of the antennas of said second array of antennas according to said second binary code.

The invention also relates to a method of locating an object in a volume with the help of a first array of scanning antennas positioned in a first plane and a second array of scanning antennas positioned in a second plane, said method comprising steps of:
first detection comprising a step consisting of detecting a first signal received by said object in response to a first electromagnetic signal emitted by said first array;
determining the position of a projection of said object in said first plane according to said first signal received;
second detection comprising a step consisting of detecting a second signal received in said volume in response to a second electromagnetic signal emitted by said second array of antennas;
determining the position of a projection of said object in said second plane according to said first signal received;
locating said object in a frame of reference made up of said first plane and said second plane, according to the position of said object in said first plane and in said second plane.

In one specific embodiment, said first detection can include a step of said object transmitting said first signal received and said second detection includes a step of said object transmitting said second signal received. This makes it possible, in particular, directly to detect the signal received by the object. This embodiment of the invention is more advantageous than a variation that consists of detecting, for example, an echo of the signal received by said object outside the volume, since the losses due to absorption by the volume make this echo of little practical use.

Also according to an embodiment of the invention, the aforementioned method can include steps wherein:
each of the antennas of said first array of antennas sequentially generates a first electromagnetic antenna signal;
each of the antennas of said second array of antennas sequentially generates a second electromagnetic antenna signal;
the first detection comprises a step consisting of determining a first antenna of said first array of antennas having generated the maximum energy of the first signal received;
the second detection comprises a step consisting of determining a second antenna of said second array of antennas having generated the maximum energy of the second signal received;
the locating step comprises a step consisting of locating said object in said frame of reference according to said first antenna and said second antenna.
   The method as described above is particularly advantageous when the object is a ferromagnetic object, for example an electrode, and the volume is a non-homogeneous medium, for example a brain. This method then makes it possible precisely to locate the ferromagnetic object in the non-homogeneous medium.

Also according to one embodiment of the invention, the aforementioned method can comprise steps consisting of:
displaying a three-dimensional image of said volume;
displaying a representation of said object on said three-dimensional image, according to the position of said object in said frame of reference.
   Also according to one embodiment of the invention, the aforementioned method can comprise steps consisting of:
generating a first digital binary code;
modulating the phase of each of the antennas of said first array of antennas according to said first digital binary code.
   Also according to one embodiment of the invention, the aforementioned method can comprise steps consisting of:
generating a second digital binary code;
modulating the phase of each of the antennas of said second array of antennas according to said second digital binary code.

### BRIEF DESCRIPTION OF DRAWINGS

An embodiment of the invention is described below in reference to the appended figures, wherein:

FIG. 1 shows a block diagram of an embodiment of the invention;

FIG. 2 depicts an emission pattern of an antenna belonging to an array of antennas according to the invention; and

FIG. 3 shows an example of a local controller of a cell in an array of antennas according to the invention.

### DETAILED DESCRIPTION

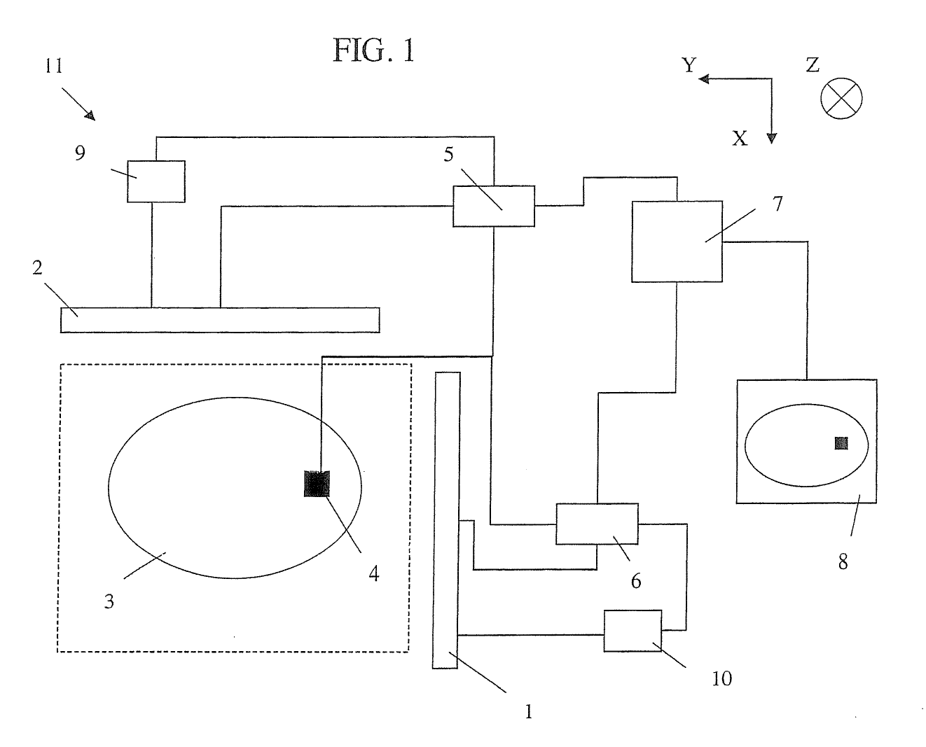

As shown in FIG. 1, a system 11 for locating an object 4 in a volume 3 comprises a first array of antennas 1, and a second array of antennas 2. The object 4 is a ferromagnetic object, for example an electrode 4, capable of receiving an electromagnetic signal emitted by the arrays of antennas 1 and 2, and of transmitting an electric signal according to these received electromagnetic signals. The volume 3 is a non-homogeneous medium, for example a human brain 3, in which we want to insert an electrode 4. This non-homogeneous medium is characterised in that it has varying electromagnetic properties within the volume.

The arrays of antennas 1 and 2 are arrays of scanning antennas, respectively controlled by controllers 10 and 9. These controllers 9 and 10 determine the moment of emission for each antenna of the arrays. The links between the arrays of antennas and the locating means are wired links or wireless radio links in the frequency band between 800 MHz and 26 GHz. The antennas emit in a frequency band comprised between 0.6 MHz and 1 GHz. In this frequency range, the waves can pass through the human brain satisfactorily, so as to be able to obtain a signal from the electrode 4, even when the latter is deeply implanted in the brain 3.

The antennas can be planar, such as patch antennas, or three-dimensional, such as horn antennas. Their main characteristics are their emitting frequency band, gain and acceptance angle. The number of antennas in an array is chosen according to the intended application, in order to create a more or less narrow emitting beam. To locate an electrode 4 in a human brain 3, each array can contain, for example sixteen antennas, operating at 1 GHz, so as to achieve a locating precision of around one millimetre. The dimensions of the antennas will be inversely proportional to their emitting frequency; this example provides overall dimensions that can be used by practitioners.

Each of these arrays of antennas 1 and 2 is respectively connected to two-dimensional locating means 6 and 5. The links between the arrays of antennas and the locating means are wired links or wireless radio links in the frequency band between 800 MHz and 26 GHz. The following is a description of the two-dimensional locating method in reference to the first array 1, but it is understood that, as regards two-dimensional locating, the two arrays play identical roles and have the same operation.

The electrode 4 receiving an electromagnetic signal from the array of antennas 1 transmits an electric signal to the two-dimensional detection means 6. This electric signal is, for example, transmitted by a wired link. The link between the electrode 4 and the locating means 6 can also be a wireless radio link in the frequency band from 800 MHz to 26 GHz.

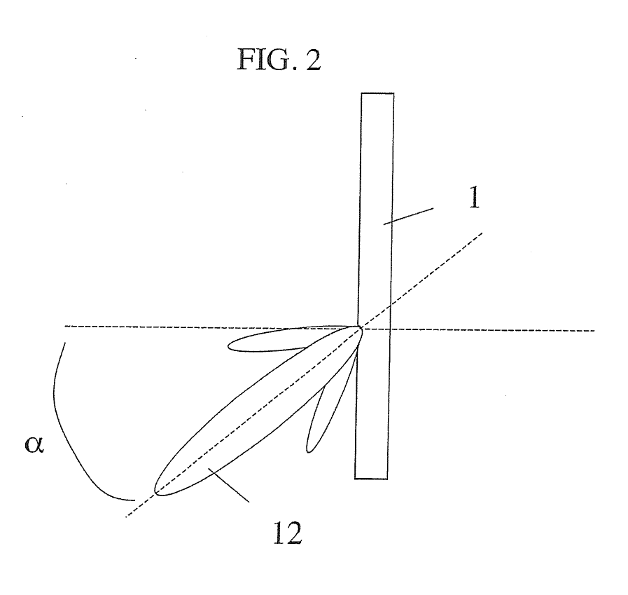

The electrode 4 captures a signal coming from the antennas, which is stronger when the beam from the antenna is pointed towards it. In fact, in a well-known manner, antennas emit in a preferred direction, in particular forming a main lobe 12 with an orientation a as shown in FIG. 2. It is then sufficient to correlate this maximum energy received with the position of the beam to find out the position of the electrode 4 in the plane of an array of antennas.

For this purpose, the scanning controller 10 transmits the scanning information to the two-dimensional locating means 6, including, in particular, the emission time of the antennas, and the electrode 4 transmits a signal according to the signal received from the antennas to the two-dimensional locating means 6. The two-dimensional locating means 6 then calculate the position of the electrode 4 in the plane of the array.

To perform these various calculations, the scanning controller 10 and the two-dimensional detection means 6 are associated with processors, possibly within a computer. By means of an identical process in the array of antennas 2 associated with the scanning controller 9, the two-dimensional locating means 5 determine the position of the electrode 4 in the plane of the array. To perform these various calculations, the scanning controller 9 and the two-dimensional locating means 5 are associated with processors, possibly within a computer.

The two-dimensional locating means 5 and 6 take into consideration known parameters of electromagnetic wave propagation in one or more media, as well as signal-processing parameters in order to improve the locating precision. A single software program, running on a computer, can possibly control the calculations made by the means 5 and 6. In this case, the software supplies the scanning order controlled by the controllers 9 and 10, then analyses the signals received by the electrode, by modulating this signal by reflection, diffraction or attenuation data representative of the trajectory of the signal. The software program then determines the time at which the electrode 4 receives the maximum energy, and calculates the position of the electrode 4 in the planes of the arrays 1 and 2, or more generally the position of a projection of the electrode 4 in the planes of the arrays 1 and 2.

With the help of the two-dimensional locations produced by the means 5 and 6, three-dimensional locating means 7 calculate the three-dimensional location of the electrode 4 in relation to the planes of the arrays 1 and 2. A software program, possibly that controlling the calculations made by the means 5 and 6, controls the calculations made by the three-dimensional locating means 7. The locating means 7 locate the electrode 4 in a frame of reference formed by the planes of the arrays 1 and 2. If these arrays are in two orthogonal planes, this calculation makes it possible directly to obtain the location in an orthogonal frame of reference that facilitates subsequent display. If the planes of the arrays are not orthogonal, but remain non-parallel, the electrode 4 is located in the planes of the arrays 1 and 2, and projections make it possible to give the position of the electrode 4 in an orthogonal frame of reference.

Once the three-dimensional location is provided by the three-dimensional locating means 7, the electrode 4 can be viewed on a display screen 8. This electrode can also be associated on the screen 8 with a representation of the volume 3 in which the electrode 4 is implanted. For this purpose, prior to locating the electrode, magnetic resonance images MRI of the human brain 3 are taken, located by calibration frames of reference in relation to the arrays 1 and 2, possibly with the help of the actual electrode positioned on the surface of the brain 3. Known three-dimensional reconstruction algorithms then make it possible, based on magnetic resonance images MRI, to display a three-dimensional representation of the brain. On the screen 8, the representation of the brain can then be moved, for example using a mouse. In this case, the brain 3 having been calibrated in relation to the arrays 1 and 2, an image of the electrode 4 will be precisely positioned in the three-dimensional representation of the brain 3, by superimposing the representation of the electrode and the representation of the brain, and this regardless of the movement of the electrode. In this way, the movement of the electrode 4 inside the brain 3 can be monitored with updates separated by less than one second.

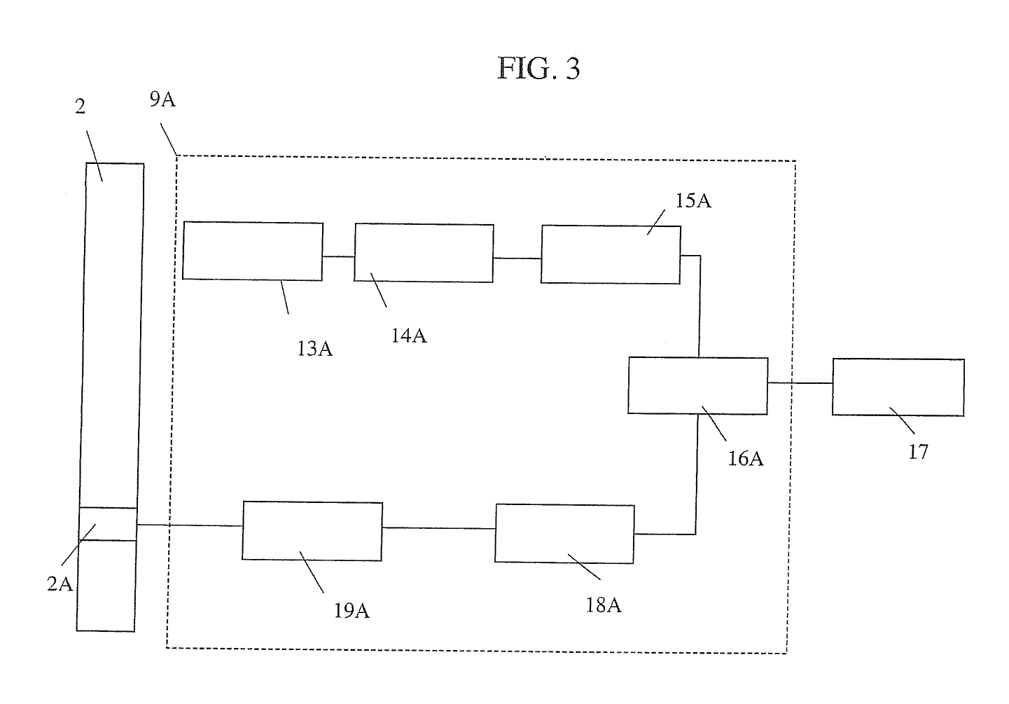

The following is a description in greater detail of the scanning controllers 9 and 10 of the arrays of antennas 1 and 2 in reference to FIG. 3. FIG. 3 shows a scanning controller 9A controlling the signal emitted by a cell of an array comprising an antenna 2A. A controller 9 is then made up of a plurality of local controllers 9A as described below, each associated with an antenna 2A of the array 2. The controller 10 associated with the array 1 has an identical structure to that of the controller 9A.

In a known array of antennas, for example in a scanning radar, the signal sent by the antennas is identical for all the antennas, but phase-shifted. However, in the devices for providing this phase shift, such as Butler matrices or diode arrays, the phase shift between the antennas is constant. The embodiment described below has the advantage of providing a variable phase shift to the antennas of the arrays 1 and 2.

As shown in FIG. 3, according to one embodiment of the invention, the local controller 9A comprises a digital symbol generator 13A, connected to a Nyquist filter 14A, in turn connected to a modulator in quadrature 15A. These elements 13A, 14A and 15A make it possible to provide a variable phase shift to the antennas of the array 2. The modulator is connected to a mixer 16A which is controlled by an oscillator 17 defining the operating frequency of the antennas. The mixer 16A is connected to an amplifier 18A which makes it possible to control the intensity of the waves emitted by the antennas, in turn connected to a band-pass filter 19A making it possible to specify the frequency band in which the antennas emit. This filter 19A is ultimately connected to the antennas of the array 2. The oscillator 17, the amplifier 18A and the filter 19A are chosen according to the application of the system 11 according to the invention. Those skilled in the trade will then be capable of choosing these components in particular according to the constraints regulating the field of application, and/or the material that makes up the volume 3.

The digital symbol generator 13A provides a binary code, called a symbol, comprising one or several bits, according to a chosen modulation. This binary code is used to encode a phase value for the antenna 2A of a cell of the corresponding array 2. The Nyquist root filter 14A makes it possible to shape the signal transmitting the binary code, mainly to avoid interference at the time of transmission. It can be used or not according to the intended application.

The modulator in quadrature 15A represents the phase shifter associated with the antenna 2A of a cell of an array. According to the digital modulation received from the symbol generator 13A, and its associated constellation, the modulator 15A generates an amplitude and/or phase-modulated analogue signal. The modulator 15A associated with the symbol generator 13A then performs a phase shift digital modulation, or PSK, standing for “Phase Shift Key”, in particular in the field of telecommunications. The phase shift supplied to the signal is then carried out according to a predefined constellation. A constellation in quadrature makes it possible, for example, to create four different phase shifts, which is to say a beam according to four distinct orientations. By increasing the number of symbols transmitted by the generator 13A, it is possible to improve the precision of the phase shift variation.

The oscillator 17 makes it possible to define the emission frequency of the antennas of the array 2. This oscillator 17 is common to all the cells of the array 2. The mixer 16A receiving a signal at the frequency defined by the oscillator 17, makes it possible to transpose the phase-shifted useful signal produced by the modulator 15A into a phase-shifted signal with the frequency defined by the oscillator 17.

The amplifier 18A makes it possible initially to adapt the power of the signal to be emitted by the antennas to the characteristics of the volume 3 containing the object 4 to be located. It can also, in combination with other amplifiers associated with other cells of the array 2, make it possible to improve the quality of the beam emitted by the antennas. The band-pass filter 19A makes it possible in particular to reduce the emission of electromagnetic waves in the frequency bands not allocated by the various frequency regulating authorities.

With the help of a group of controllers 18A such as previously described, it is possible to create a multitude of phase differences in the emissions of the antennas of the array 2, so as to achieve satisfactory locating precision. The precision of the locating of the electrode 4 in the brain 3 according to the invention therefore makes is possible, in the medical field, to treat diseases for which it is necessary to apply a specific electric signal on a very local basis.

1.-18. (canceled)

19. A system for locating an object in a volume, the system comprising:
a first array of scanning antennas positioned in a first plane;
a first detector arranged so as to detect a first signal received by said object in response to a first electromagnetic signal emitted by said first array towards said volume;
a first two-dimensional locater arranged so as to determine the position of a projection of said object in said first plane according to said first signal received;
a second array of scanning antennas positioned in a second plane, said second plane being non-parallel to said first plane;
a second detector arranged so as to detect a second signal received by said object in response to a second electromagnetic signal emitted by said second array of antennas towards said volume;
a second two-dimensional locater arranged so as to determine the position of a projection of said object in said second plane according to said second signal received; and
a three-dimensional locater arranged so as to locate said object in a frame of reference made up of said first plane and said second plane, according to the position of said object in said first plane and in said second plane.

20. The system according to claim 19, wherein said first plane and said second plane are orthogonal.

21. The system according to claim 19, further comprising a first scanner capable of causing the sequential generation of a first electromagnetic antenna signal by each of the antennas of said first array of antennas, and a second scanner capable of causing the sequential generation of a second electromagnetic antenna signal by each of the antennas of said second array of antennas, said first two-dimensional locater further comprising a first correlater arranged so as to determine a first antenna of said first array of antennas having generated a maximum energy of the first signal received, said second two-dimensional locater further comprising a second correlater arranged so as to determine a second antenna of said second array of antennas having generated a maximum energy of the second signal received.

22. The system according to claim 19, further comprising means for viewing the volume arranged so as to display a three-dimensional image of said volume, and superimposing means arranged so as to display a representation of said object on said three-dimensional image, according to the position of said object in said frame of reference.

23. The system according to claim 19, wherein the object is a ferromagnetic object and the volume is a non-homogeneous medium.

24. The system according to claim 19, wherein the object is an electrode and the non-homogeneous medium is a brain.

25. The system according to claim 19, further comprising:
a first digital symbol generator capable of generating a first binary code; and
a first modulator capable of modulating the phase of each of the antennas of said first array of antennas according to said first binary code.

26. The system according to claim 25, further comprising:
a second digital symbol generator capable of generating a second binary code; and
a second modulator capable of modulating the phase of each of the antennas of said second array of antennas according to said second binary code.

27. The system according to claim 19, further comprising an oscillator capable of defining the emission frequency of the antennas of said first array of antennas and of said second array of antennas.

28. A method of locating an object in a volume with the help of a first array of scanning antennas positioned in a first plane and a second array of scanning antennas positioned in a second plane, said method comprising:
first detection comprising detecting a first signal received by said object in response to a first electromagnetic signal emitted by said first array;
determining the position of a projection of said object in said first plane according to said first signal received;
second detection comprising detecting a second signal received in said volume in response to a second electromagnetic signal emitted by said second array of antennas;
determining the position of a projection of said object in said second plane according to said second signal received; and
locating said object in a frame of reference made up of said first plane and said second plane, according to the position of said object in said first plane and in said second plane.

29. The method according to claim 28, wherein said first detection includes a step of transmission by said object of said first signal received.

30. The method according to claim 28, wherein said second detection includes transmission by said object of said second signal received.

31. The method according to claim 28, further comprising:
each of the antennas of said first array of antennas sequentially generates a first electromagnetic antenna signal;
each of the antennas of said second array of antennas sequentially generates a second electromagnetic antenna signal;
the first detection further comprises determining a first antenna of said first array of antennas having generated the maximum energy of the first signal received;
the second detection further comprises determining a second antenna of said second array of antennas having generated the maximum energy of the second signal received; and
the location step further comprises locating said object in said frame of reference according to said first antenna and said second antenna.

32. The method according to claim 28, further comprising:
displaying a three-dimensional image of said volume; and
displaying a representation of said object on said three-dimensional image, according to the position of said object in said frame of reference.

33. The method according to claim 28, wherein the object is a ferromagnetic object and the volume is a non-homogeneous medium.

34. The method according to claim 33, wherein the object is an electrode and the non-homogeneous medium is a brain.

35. The method according to claim 28, further comprising:
generating a first digital binary code; and
modulating the phase of each of the antennas of said first array of antennas according to said first digital binary code.

36. The method according to claim 28, further comprising:
generating a second digital binary code; and
modulating the phase of each of the antennas of said second array of antennas according to said second digital binary code.
